(19) United States
(12) Patent Application Publication
(10) Pub. No.: US 2023/0225379 A1
(43) Pub. Date: Jul. 20, 2023

(54) HEAT-TREATED GERMINATED PULSE AND METHOD FOR PREPARING THE SAME

(71) Applicant: VIKING MALT OY, Lahti (FI)

(72) Inventors: Terhi HAKALA, (US); Annika WILHELMSON, Lahti (FI); Raimo KOLJONEN, Lahti (FI); Heikki AISALA, Espoo (FI); Pia SILVENTOINEN-VEIJALAINEN, Espoo (FI)

(21) Appl. No.: 18/010,376

(22) PCT Filed: Jun. 15, 2021
(86) PCT No.: PCT/FI2021/050450

§ 371 Date: Dec. 14, 2022

(30) Foreign Application Priority Data
Jun. 16, 2020 (FI) 20205634

(51) Int. Cl. A23L 11/70; A23L 11/30; A23K 10/30

(52) U.S. Cl. CPC A23L 11/70; A23L 11/31; A23K 10/30

(57) ABSTRACT

The invention relates to pulse products with improved flavor properties and digestive comfort. More specifically, the invention relates to a heat-treated germinated pulse and to a method of producing a heat-treated germinated pulse.

### FIELD OF THE INVENTION

The invention relates to pulse products with improved flavor properties and digestive comfort. More specifically, the invention relates to a heat-treated germinated pulse and to a method of producing a heat-treated germinated pulse.

### BACKGROUND OF THE INVENTION

Legumes are grown primarily for human consumption, for livestock forage and silage, and as soil-enhancing green manure. Well-known legumes include alfalfa, clover, beans, peas, chickpeas, lentils, lupins, mesquite, carob, soybeans, peanuts, and tamarind. Legumes produce a simple dry fruit that develops from a simple carpel and usually dehisces (opens along a seam) on two sides. The fruit or seed of such a leguminous plant is also called a pulse, especially in the mature, dry condition. Legumes and pulses are a significant source of protein, dietary fiber, carbohydrates and dietary minerals.

Humans have domesticated and cultivated various legumes over thousands of years, with first evidence of legume utilization by man dating back more than 10,000 years. Especially in the recent years, there has been an increasing interest in supplementing and replacing animal protein used in nutrition with plant protein such as pulse protein. At the same time, global food security challenges are on the increase and protein malnutrition continues to be a problem in many countries around the world. Pulses may offer an alternative source for nutritional and functional proteins, especially when consumed together with cereals which comprise sulphur-containing amino acids.

Pulses are even now an important source of food proteins for billions of people. They contain high amounts of lysine, leucine, aspartic acid, glutamic acid and arginine and provide well-balanced essential amino acid profiles. The protein content of most pulse legumes falls within the range of 17-30 weight-% based on dry weight (dw).

The presence of alpha-galacto-oligosaccharides (e.g. raffinose, stachyose, and verbascose) in pulses limits their utilization. These oligosaccharides cause digestive discomfort due to the presence of α-galactosidic bonds which humans lack the enzyme, α-galactosidase, to break. Anaerobic fermentation of undigested carbohydrates by intestinal micro-organisms leads to the production of gases such as H₂, CO₂ and CH₄, which cause abdominal discomfort, flatulence and diarrhoea.

In addition, pulse protein has poor digestibility which is a major constraint for its utilization in food. Digestibility is a measure of susceptibility of proteins to proteolysis and an indicator of protein availability. Highly digestible proteins are more desirable since they provide more amino acids for absorption on proteolysis, and therefore have better nutritional value than proteins with low digestibility. To improve shelf-life and flavor pulses are often heat treated by e.g. boiling, steaming or kilning which may further deteriorate protein solubility and digestibility and cause damage to functional properties and applicability of pulse protein in food products.

Moreover, heat treatment of pulses may also cause changes in the flavor profiles of pulses through e.g. fatty acid oxidation which leads to formation of off-flavor compounds including short-chain aldehydes and alcohols. The formation of off-flavors may decrease the sensory quality of the pulses as they may have a negative impact on e.g. odor and flavors.

Thus, there is a longstanding need for pulse products with improved digestibility and flavor properties.

### BRIEF DESCRIPTION OF THE INVENTION

In an aspect, the present invention relates to a heat-treated germinated pulse. In a further aspect, the present invention relates to a method for producing a heat-treated germinated pulse. The objects of the invention are achieved by a heat-treated germinated pulse and a method for producing a heat-treated germinated pulse which are characterized by what is stated in the independent claims. The embodiments of the invention are disclosed in the dependent claims.

In an aspect, the invention is based on the realization that the method involves a unique and industrially feasible combination of conditions to produce the heat-treated, germinated pulse. In particular, the heat treatment by a combination of steaming and kilning steps under predetermined conditions produces the pulse with improved flavor properties and digestive comfort.

The method of preparing a heat-treated germinated pulse comprises the steps of:

a) steeping,

b) germinating,

c) steaming at a temperature of up to 95° C. for more than 20 s, and

d) kilning at less than 105° C.

In another aspect, the invention is based on the realization that treating a germinated pulse with steaming and kilning under predetermined conditions produces a pulse with improved digestive comfort and flavor properties. Particularly, the 1-hexanol content of the heat-treated and germinated pulse is reduced by the heat treatment, improving its sensory properties. The heat-treated germinated pulse comprises a 1-hexanol content of less than 200 μg/g.

In yet another aspect, the invention relates to a food or feed product comprising the heat-treated germinated pulse. In still another aspect, the invention relates to use of the heat-treated germinated pulse as a food or feed product or in a food or feed product or in producing a food or feed product.

An advantageous feature of the heat-treated germinated pulse is that the pulse has improved sensory properties including reduced bitterness, astringency and overripe fruit odor as compared to non-germinated native raw material, as well as less intense beany and fermented flavor and beany odor as compared to unsteamed germinated material. In addition, kilning conditions may be adjusted to produce a more intense roasted and cereal flavor and odor. Simultaneously, the heat-treated and germinated pulse has improved digestive properties. The improved properties are based on a decreased content of volatile off-flavors and alpha-galactosides in the pulse while maintaining protein solubility.

### BRIEF DESCRIPTION OF THE DRAWINGS

In the following the invention will be described in greater detail by means of embodiments with reference to the accompanying drawings, in which

FIG. 1 illustrates 12 sensory attributes of steeped (5 h) or germinated (2 d or 3 d) faba bean (Vicia faba, also known as fava bean) samples studied with generic descriptive analysis. Non-steeped, non-germinated raw material (Native) was also included for comparison. All samples were dried by kilning at 55° C. (i.e. EM kilning), dehulled and milled prior to the analysis. For attribute intensity evaluation, 0-10 line scales were used where 0=the attribute was not perceived at all and 10=the attribute was perceived as very intense in the sample. The asterisks indicate attributes where the samples differed statistically significantly (p<0.05) in the two-way mixed model analysis of variance (ANOVA) i.e. where the panel detected a systematic difference between samples and the attribute therefore sorted the samples;

FIG. 2 illustrates sensory attributes of germinated (all samples: 2 d=48 h germination), steamed (5 min or 25 min at 60° C. or 25 min at 65° C. or unsteamed) and kilned (55° C.=EM or 83° C.=PM) faba bean (Vicia faba) samples studied with generic descriptive analysis. Of the studied attributes, FIG. 2a illustrates the four attributes related to odor, and FIG. 2b shows the seven sensory attributes related to flavor. For attribute intensity evaluation, 0-10 line scales were used where 0=the attribute was not perceived at all and 10=the attribute was perceived as very intense in the sample. The asterisks indicate attributes where the samples differed statistically significantly (p<0.05) in the two-way mixed model analysis of variance (ANOVA) i.e. where the panel detected a systematic difference between samples and the attribute therefore sorted the samples;

FIG. 3 illustrates the differences in the volatile compound profiles analyzed with headspace-solid phase microextraction-gas chromatography-mass spectrometry (HS-SPME-GC-MS). The data was subjected to Principal Component Analysis; all variables were autoscaled. FIG. 3 is a Bi-plot of the first two principal components that explain 91% of the data variation;

FIG. 4 illustrates the volatile compounds that are associated with the sensory properties in FIG. 2. Data from FIG. 2 and FIG. 3 were combined in a Partial Least Squares Regression (PLSR) model; the volatile compounds were autoscaled while sensory data was only mean-centered. The sample types were projected onto the model as down-weighted dummy variables.

### DETAILED DESCRIPTION OF THE INVENTION

The present invention relates to a pulse which has improved flavor properties and retains functionality and applicability for use in food products. The pulse with improved properties is a heat-treated and germinated pulse produced by steeping, germinating, steaming and kilning the pulse.

Germination is from the process by which an organism such as a leguminous plant grows from a seed. Water is required for germination as seeds are typically dry and need to take in water before cellular metabolism and growth can resume. Uptake of water leads to swelling and breaking of the seed coat. Seeds contain a nutrient reserve which provides nourishment to the growing embryo. When the seed imbibes water, enzymes are activated which breaks down the food reserve into metabolically useful chemicals. For pulses, steeping is performed to introduce water into the pulse seeds in preparation for germination.

As used herein, steeping refers to soaking the pulse in a liquid such as water or an aqueous solution or spraying the pulses with the liquid. Steeping may also be performed by a combination of soaking and spraying. The aqueous solution may comprise one or more agent(s) which e.g. inhibit(s) microbial growth. Steeping may be performed by soaking the pulses in the liquid or spraying the pulses with the liquid for a predetermined time, and/or until for example a desired moisture content is achieved. In addition to soaking or spraying, steeping may be performed by any manner with which a moisture content of at least 40% (w/w) or 40-60% (w/w) in the pulse is achieved.

During steeping, the liquid may be replaced one or more times with fresh liquid either completely or partially, or the same liquid may be used throughout steeping without replacing it even partially. Steeping may be performed in one step by continuously soaking or spraying the pulse or it may comprise one or more intermediate or terminal step(s) of dry steeping. Dry steeping is performed by removing the liquid from wet steeped pulses by draining e.g. via a discharge valve located at the bottom of the soaking vessel. The discharge valve may include a sieve to prevent exit of the pulse seeds with the liquid. The uptake of water by the pulse seeds occurs by two distinct routes—actively by the embryo and passively via imbibition through the surface of the seed. Dry steeping balances this combination of water uptake mechanisms and increases the time for starting the bioprocesses within the seed as the liquid is drained, while the increase in moisture content within the seed continues, but at a slower pace, due to the liquid remaining on the surface of the seed. In case the seed is sensitive to excess water, the correct cycle of wet and dry steeping is especially important. In addition, by replacing the liquid used for steeping, the steeped material is simultaneously purified.

Legume seeds comprise polysaccharides and oligosaccharides such as the alpha-galactosides raffinose, verbascose and stachyose. The alpha-galactosides are considered antinutritives as the human intestinal mucosa lacks the enzyme the break them down, and the sugars themselves cannot pass the intestinal wall. Anaerobic fermentation of the alpha-galactosides by gut microbiota leads to formation of gas and causes discomfort, pain, cramping, flatulence and diarrhoea. The enzymatic activity during germination breaks down the antinutritive alpha-galactosides, producing smaller-size saccharides such as sucrose which are more readily digestible.

Raffinose C₁₈H₃₂O₁₆ is a trisaccharide composed of galactose, glucose, and fructose. Stachyose C₂₄H₄₂O₂₁ is a tetrasaccharide consisting of two galactose units, one glucose unit, and one fructose unit. Verbascose C₃₀H₅₂O₂₆ is a pentasaccharide composed of 3 galactoses, a glucose unit and a fructose unit.

As evidenced by the studies presented herein, germination may reduce the content of alpha-galactosides in the pulse while the content of sucrose may increase. In an embodiment, the alpha-galactoside content comprised in the germinated pulse given as mg/g dry matter (dm) is 20 mg/g dm or less, preferably 15 mg/g dm or less, more preferably 10 mg/g dm or less, even more preferably 5 mg/g dm or less, wherein the alpha-galactoside content is the sum of content of raffinose, stachyose and verbascose in mg/g dm. In a further embodiment, the sucrose content comprised in the germinated pulse is at least 20 mg/g dm, preferably at least 30 mg/g dm, more preferably at least 40 mg/g dm, even more preferably at least 50 mg/g dm. The alpha-galactoside and sucrose contents in the germinated pulse typically remain essentially similar during subsequent heat-treatment(s) so that the heat-treated germinated pulse comprises essentially the same alpha-galactoside and sucrose contents.

In an embodiment, the alpha-galactoside content comprised in the germinated pulse of 20 mg/g dm or less, preferably 15 mg/g dm or less, more preferably 10 mg/g dm or less, even more preferably 5 mg/g or less and/or the sucrose content comprised in the germinated pulse of at least 20 mg/g dm, preferably at least 30 mg/g dm, more preferably at least 40 mg/g dm, even more preferably at least 50 mg/g dm occurs typically within 1 d (24 h), within 2 d (48 h), within 3 d (72 h), within 4 d (96 h) or within 5 d (120 h) of germination.

Sensory properties of steeped and germinated pulses were assessed with generic descriptive analysis in the studies presented herein. The reference products, untreated (native) raw material and steeped material had more overripe fruit flavor and odor and yeasty odor and were more astringent and bitter, whereas the germinated samples had more pea-like odor and bean-like flavor. Astringency and bitterness are often associated with unripeness, whereas overripe flavor and yeasty odor are considered unpleasant in pulses. As compared to the reference samples, germinated samples had fewer sensory properties that are considered unpleasant, and more attributes such as pea-like odor and bean-like flavor which are typically associated with pulses.

To make pulses edible, pulses are typically heat treated by e.g. boiling to cook the pulse seeds and inactivate antinutritives such as lectin. Heat treatment may be preceded by steeping to soften the seed, to achieve a more consistent texture and to shorten the heat treatment time. Steeping may also somewhat reduce the content of the antinutritive oligosaccharides alpha-galactosides in the pulse, as is also evidenced by the studies presented herein. In addition to alpha-galactosides, pulse seeds typically comprise other antinutritive compounds such as lectins, trypsin inhibitors, phytic acid, and tannins. Lectins are carbohydrate-binding proteins, which, when consumed, may bind in the gut to a wide variety of cell membranes and glycoconjugates of the intestinal and colonic mucosa, leading to deleterious effects on the mucosa as well as on other inner organs and the intestinal bacterial flora. Trypsin inhibitors inhibit the protein digesting enzyme trypsin and thus reduce protein digestibility. Phytic acid reduces mineral and potentially protein bioavailability. Tannins can decrease activity of digestive enzymes and reduce protein and mineral bioavailability. The effects of heat treating may include a reduction in the amount of tannins, trypsin inhibitors and lectin.

A disadvantage associated with heat treating pulse seeds by boiling to cook them is that cooking may degrade the texture of the pulse, destroy nutrients and denature pulse protein. In the denatured state, pulse protein loses its solubility and technological functionality, which impairs pulse protein applicability in food products. Pulse flours, protein concentrates and isolates can be incorporated into various foods to increase their nutritional value and/or to provide specific and desirable functional attributes. Protein solubility plays a major role in various food applications as a number of functional attributes such as foaming, gelation or thickening, oil holding and water hydration capacities, and emulsification are closely related and often dependent on protein solubility. Moreover, functional properties of pulse proteins contribute an important aspect in determining the applicability of protein ingredients in food products, as they can impact the texture of food. The functional attributes of pulse proteins vary considerably due to differences in processing. A heat treatment by steaming may be used to avoid the effects of over-processing and deteriorated applicability of pulses which are associated with cooking. In addition, steaming is less energy-intensive to perform and requires smaller reaction volumes than boiling due to no need of immersion in water or an aqueous solution for cooking the pulses.

Pulse seeds with high moisture content such as those that have been steeped and/or heat treated by boiling or steaming in an aqueous solution or water are typically dried to improve storage properties of the seeds and their applicability for further processing such as dehulling or milling. Drying may be performed e.g. by kilning which refers to drying by heating of the pulse. Kilning may be performed at predetermined conditions including a set temperature and time. Alternatively or additionally, kilning may be performed until a predetermined residual moisture content is achieved.

Drying, especially when performed by kilning, typically affects functional and sensory attributes of the pulse, including protein solubility, odor and flavor. Enzymatic activity that commences e.g. during steeping and germination also comprises activity of lipid modifying enzymes such as lipase and lipoxygenase. These enzymes act to break down long-chained lipids and fatty acids, producing smaller molecules such as aldehydes and alcohols, some of which are volatiles i.e. have a low boiling point and high vapor pressure at room temperature. Many of these aldehydes and alcohols are considered off-flavor compounds which affect the sensory attributes of pulses in a negative manner, causing unpleasant odor and flavor. On the other hand, during germination, concentration of some of these off-flavor molecules may in fact again decrease from their initial or interim concentration as they are consumed in metabolic reactions within the germinating seed. Heat treatment of pulses such as boiling, steaming and kilning may act to further reduce the content of these off-flavors by reducing enzymatic activity and by removing off-flavor compounds through e.g. evaporation and sublimation. On the other hand, heat treatment may also cause heat-induced oxidation of fatty acids and lead to an increase in the concentration of off-flavor compounds. Thus, there exists a delicate balance between selecting suitable treatment conditions and achieving favorable sensory characteristics for the treated pulse.

Heat treatment conditions affect pulse protein solubility as evidenced by the studies presented herein. In germinated faba beans treated with kilning at different temperatures or steaming in combination with kilning, protein solubility at pH 7 remained above 88% i.e. at similar level to protein solubility of untreated raw material when only kilning was performed. Increasing kilning temperature to 105° C. had no significant effect on protein solubility. However, when steaming was performed prior to kilning, protein solubility decreased significantly, and was further decreased at high kilning temperatures. It was discovered that protein solubility remained satisfactory i.e. above 60% when a steaming temperature of about 70° C. or less was used in combination with kilning at a temperature of less than 105° C. Protein solubility is determined as the percentage of soluble protein in total protein content. E.g. in an ingredient having a total protein content of 36 g protein per 100 g of ingredient, and 21.6 g of soluble protein per 100 g of ingredient, protein solubility is 60%.

In an embodiment, the heat-treated germinated pulse comprises a protein solubility of at least 60%, of total protein, preferably at least 65%, more preferably at least 70%.

As used herein, the term “about” refers to a range of values ±10% of a specified value. For example, the phrase “about 70° C.” includes ±10% of 70° C., or from 63° C. to 77° C.

As used herein, the term “or” has the meaning of both “and” and “or” (i.e. “and/or”). Furthermore, the meaning of a singular noun includes that of a plural noun and thus a singular term, unless otherwise specified, may also carry the meaning of its plural form. In other words, the term “a” or “an” may mean one or more.

As discussed above, heat treatment conditions may also affect lipid modifying enzymes. As evidenced by the studies presented herein, lipase activity was surprisingly not significantly affected by kilning at 55° C., and kilning at 83° C. left more than two thirds of lipase activity intact. However, the combination of steaming and kilning inactivated lipase effectively when steaming duration was longer than 20 seconds, i.e. 5 min or 25 min at any of the tested steaming and kilning temperatures. For lipoxygenase, kilning temperature had a more pronounced effect, with lipoxygenase activity reduced to below 40% of the activity in the untreated raw material at a kilning temperature of 83° C. without steaming. With kilning at 55° C. and no steaming, lipoxygenase activity remained at a similar level than in the untreated raw material.

In an embodiment, the heat-treated germinated pulse comprises a lipase activity of 1 μmol/min/g dm or less, preferably less than 1 μmol/min/g dm, more preferably 0.5 μmol/min/g dm or less, even more preferably 0.2 μmol/min/g dm or less.

In an embodiment, the heat-treated germinated pulse comprises a lipoxygenase activity of 100 μmol/min/g dm or less, preferably less than 100 μmol/min/g dm, more preferably 90 μmol/min/g dm or less, even more preferably 80 μmol/min/g dm or less.

Major lipid-derived volatiles in pulses that often contribute to off-flavors in pulses comprise the aldehydes heptanal, hexanal and nonanal and alcohols 1-hexanol and 1-nonanol as well as the fatty acid nonanoic acid. The content of the aldehydes heptanal, hexanal and nonanal in pulses may decrease during germination, but as evidenced by the studies presented herein, the content may again increase due to heat treating. Especially the combination of steaming for periods longer than 20 s and high-temperature kilning cause an increase in aldehyde content. However, 1-hexanol behaves in a completely different manner. It has surprisingly been discovered that a heat-treatment including steaming performed for more than 20 seconds, such as 1 min, 5 min or 25 min, efficiently reduces the content of 1-hexanol in the germinated pulse, whereas heat-treatment by kilning alone does not have a such a strong decreasing effect on 1-hexanol content. A similar pattern is detectable with 1-nonanol and nonanoic acid—the most efficient reduction in 1-nonanol and nonanoic acid content is achieved with a heat treatment including steaming and not with kilning alone. However, the relative reduction in content by heat treating is typically smaller with 1-nonanol and nonanoic acid than with 1-hexanol, which may be due to 1-hexanol typically being present in higher amounts than 1-nonanol and/or nonanoic acid after germination.

1-hexanol, also known as hexan-1-ol, hexanol and hexyl alcohol is an organic alcohol with a six-carbon chain and a condensed structural formula of CH₃(CH₂)₅OH. 1-nonanol, also known as nonan-1-ol, nonanol and nonyl alcohol, is a straight chain fatty alcohol with nine carbon atoms and the molecular formula CH₃(CH₂)BOH. Nonanoic acid, also known as pelargonic acid or nonylic acid, is a nine-carbon straight-chain saturated fatty acid. Heptanal, also known as heptaldehyde or enanthaldehyde is a seven-carbon alkyl aldehyde. Hexanal, also known as caproaldehyde or hexaldehyde, is a six-carbon alkyl aldehyde. Nonanal, also known as pelargonaldehyde, 1-nonanal and nonanaldehyde, is a nine-carbon saturated fatty aldehyde.

In addition, it has surprisingly been discovered that the total content (sum) of the volatile compounds typically contributing to off-flavors—heptanal, hexanal, nonanal, 1-hexanol, 1-nonanol and nonanoic acid—correlates well with total odor intensity, whereas 1-hexanol, 1-nonanol and nonanoic acid are strongly associated with astringency, fermented flavor and beany odor and flavor which are typically considered unpleasant in a heat-treated pulse product.

Kilning of steamed pulse at a lower temperature (55° C. i.e. EM kilning) produces a pulse with lower total odor intensity than kilning a steamed pulse at a higher temperature (83° C. i.e. PM kilning) or kilning an unsteamed pulse at either temperature. This is likely associated with the total content of volatiles contributing to off-flavors being lower in steamed EM-kilned samples as compared to steamed PM-kilned samples and unsteamed EM- or PM-kilned samples. Steaming effectively reduces 1-hexanol, 1-nonanol and nonanoic acid content, and kilning at lower temperature i.e. milder conditions does not produce as large amounts of and/or produces a different range of volatiles through heat-induced oxidation than kilning at a higher temperature. By adjusting steaming and kilning temperature and duration, the sensory attributes of pulse can thus be adjusted. Especially, astringency, beany odor and flavor and fermented flavor can be removed from the germinated pulse by steaming. A subsequent lower-temperature kilning gives a product with milder total odor intensity, whereas higher-temperature kilning gives a product with higher roasted and cereal odor and flavor intensity.

In an embodiment, the heat-treated germinated pulse comprises a 1-hexanol content of less than 100 μg/g, preferably less than 80 μg/g, more preferably less than 50 μg/g. In another embodiment, the heat-treated germinated pulse comprises a 1-hexanol content of less than 200 μg/g, preferably less than 180 μg/g. In yet another embodiment, the heat-treated germinated pulse comprises a 1-hexanol content of less than 200 μg/g, preferably less than 180 μg/g, more preferably less than 100 μg/g, even more preferably less than 80 μg/g, most preferably less than 50 μg/g.

In an embodiment, the heat-treated germinated pulse comprises a 1-nonanol content of less than 50 μg/g, preferably less than 30 μg/g, more preferably of less than 20 μg/g.

In an embodiment, the heat-treated germinated pulse comprises a total content of 1-hexanol, 1-nonanol and nonanoic acid of less than 150 μg/g, preferably less than 110 μg/g. In other words, the heat-treated germinated pulse comprises a volatiles content of less than 150 μg/g, preferably less than 110 μg/g, wherein the volatiles content is a sum of content of 1-hexanol, 1-nonanol and nonanoic acid in μg/g. In another embodiment, the heat-treated germinated pulse comprises a total content of 1-hexanol, 1-nonanol and nonanoic acid of less than 250 μg/g, preferably less than 220 μg/g. In other words, the heat-treated germinated pulse comprises a volatiles content of less than 250 μg/g, preferably less than 220 μg/g, wherein the volatiles content is a sum of content of 1-hexanol, 1-nonanol and nonanoic acid in μg/g. In yet another embodiment, the heat-treated germinated pulse comprises a total content of 1-hexanol, 1-nonanol and nonanoic acid of less than 250 μg/g, preferably less than 220 μg/g, more preferably less than 150 μg/g, most preferably less than 110 μg/g. In other words, the heat-treated germinated pulse comprises a volatiles content of less than 250 μg/g, preferably less than 220 μg/g, more preferably less than 150 μg/g, most preferably less than 110 μg/g, wherein the volatiles content is a sum of content of 1-hexanol, 1-nonanol and nonanoic acid in μg/g.

In an embodiment, the heat-treated germinated pulse comprises a total content of heptanal, hexanal, nonanal, 1-hexanol, 1-nonanol and nonanoic acid of more than 300 μg/g, preferably more than 400 μg/g. In other words, the heat-treated germinated pulse comprises a volatiles content of more than 300 μg/g, preferably more than 400 μg/g, wherein the volatiles content is a sum of content of heptanal, hexanal, nonanal, 1-hexanol, 1-nonanol and nonanoic acid in μg/g. In another embodiment, the heat-treated germinated pulse comprises a total content of heptanal, hexanal, nonanal, 1-hexanol, 1-nonanol and nonanoic acid of more than 500 μg/g, preferably more than 550 μg/g. In other words, the heat-treated germinated pulse comprises a volatiles content of more than 500 μg/g, preferably more than 550 μg/g, wherein the volatiles content is a sum of content of heptanal, hexanal, nonanal, 1-hexanol, 1-nonanol and nonanoic acid in μg/g.

In an embodiment, the heat-treated germinated pulse comprises a 1-hexanol content that is less than 15% of the total (sum) content of heptanal, hexanal, nonanal, 1-hexanol, 1-nonanol and nonanoic acid, preferably less than 10%, more preferably less than 5%. Alternatively or additionally, the heat-treated germinated pulse comprises a total (sum) content of 1-hexanol, 1-nonanol and nonanoic acid that is less than 20% of the total (sum) content of heptanal, hexanal, nonanal, 1-hexanol, 1-nonanol and nonanoic acid, preferably less than 15%, more preferably less than 10%.

In another embodiment, the heat-treated germinated pulse comprises a 1-hexanol content that is less than 40% of the total (sum) content of heptanal, hexanal, nonanal, 1-hexanol, 1-nonanol and nonanoic acid, preferably less than 35%, more preferably less than 30%. Alternatively or additionally, the heat-treated germinated pulse comprises a total (sum) content of 1-hexanol, 1-nonanol and nonanoic acid that is less than 50% of the total (sum) content of heptanal, hexanal, nonanal, 1-hexanol, 1-nonanol and nonanoic acid, preferably less than 45%, more preferably less than 40%.

In yet another embodiment, the heat-treated germinated pulse comprises a 1-hexanol content that is less than 40% of the total (sum) content of heptanal, hexanal, nonanal, 1-hexanol, 1-nonanol and nonanoic acid, preferably less than 35%, more preferably less than 30%, even more preferably less than 15%, yet more preferably less than 10%, most preferably less than 5%. Alternatively or additionally, the heat-treated germinated pulse comprises a total (sum) content of 1-hexanol, 1-nonanol and nonanoic acid that is less than 50% of the total (sum) content of heptanal, hexanal, nonanal, 1-hexanol, 1-nonanol and nonanoic acid, preferably less than 45%, more preferably less than 40%, even more preferably less than 20%, yet more preferably less than 15%, most preferably less than 10%.

The pulse may be from any leguminous plant. In an embodiment, the pulse is selected from the group consisting of Vicia faba, Pisum sativum, Cicer arietinum, Lens culinaris, Lupinus sp., Phaseolus sp., Vigna sp. and a mixture thereof. In a further embodiment, the pulse is Vicia faba, Lupinus sp., Pisum sativum or a mixture thereof. In a yet further embodiment, the pulse is not Glycine max.

The invention also relates to use of the heat-treated germinated pulse as a food or feed product or in a food or feed product or in producing a food or feed product. The heat-treated germinated pulse as such or after dehulling and/or milling can be applied in production of various food or feed products in a similar manner as any dried pulse. The pulse flour obtained after dehulling and milling can be used as an ingredient in foods including, but not limited to, plant-based yogurt-like spoonable products, plant-based beverages, dry-extruded puffed snacks, plant-based meat-like products such as dry- or wet-extruded plant-based meat-like products, or baked products.

The invention also relates to a food or feed product comprising the heat-treated germinated pulse. The food product may be any of, but is not limited to, the following: plant-based yogurt-like spoonable products, plant based beverages, dry-extruded puffed snacks, plant-based meat-like products such as dry- or wet-extruded plant-based meat-like products, or baked products.

The invention also relates to a method for producing a heat-treated germinated pulse. The method comprises the steps of steeping, germinating, steaming and kilning. In an aspect, the heat-treated germinated pulse is obtainable by the method. Any details of the embodiments or aspects disclosed herein with respect to the heat-treated germinated pulse apply to embodiments concerning said heat-treated germinated pulse that is obtainable by the method, even if not repeated here.

As discussed hereinabove, steeping is performed before germination to e.g. achieve a suitable moisture content for germination. In an embodiment, the moisture content of pulse seeds after steeping is at least 40% (w/w), preferably at least 50% (w/w), more preferably at least 53% (w/w). In a further embodiment, the moisture content of pulse seeds after steeping is 40%-60% (w/w), preferably 50%-60% (w/w), more preferably about 53%-57% (w/w).

During steeping, the liquid used for steeping may be replaced one or more times with fresh liquid either completely or partially, or the same liquid may be used throughout steeping without replacing it even partially. In an embodiment, steeping is performed as wet steeping. During wet steeping phase the steeping vessel may be aerated to achieve a level of dissolved oxygen of 5-10 mg/l. Optionally, steeping may also comprise dry steeping. During the dry steeping phase CO₂ may be removed from the pulses with a continuous air flow through the pulses. Removal of CO₂ may be carried out to achieve a CO₂ level of below 10,000 ppm, preferably below 5,000 ppm, more preferably below 2,000 ppm.

In an embodiment, steeping is performed in one step, preferably as wet steeping.

In an embodiment, steeping is performed as comprising step(s) of wet steeping and dry steeping. In another embodiment, steeping comprises the steps of a wet steep, a dry steep and a further wet steep. In a further embodiment wet steeping is performed for more than 0 h, or 0-26 h, preferably 1-26 h, more preferably 2-10 h, even more preferably about 5 h. In a yet further embodiment dry steeping is performed for more than 0 h or 0-26 h, preferably 1-26 h, more preferably 10-20 h, even more preferably about 12-16 h. In a still further embodiment the further wet steeping is performed for more than 0 h or 0-26 h, preferably 1-26 h, more preferably 2-10 h, even more preferably about 5 h. As disclosed herein, wet steeping may be performed by soaking the pulses in liquid or spraying the pulses with liquid. Steeping may also be performed as a combination of spraying and soaking. In an embodiment, steeping comprises wetting the pulses prior to germination. That is, germination commences immediately after the steeping step comprising of wetting i.e. adding liquid to the pulses. Optionally, after steeping comprising of wetting the pulses, a moisture content of the pulse seeds such as at least 40% (w/w), preferably at least 50% (w/w), more preferably at least 53% (w/w), or 40%-60% (w/w), preferably 50%-60% (w/w), more preferably about 53%-57% (w/w) is achieved.

In an embodiment, steeping is performed at a temperature of at least 0° C., preferably 0-30° C., more preferably at 10-20° C., even more preferably at 13-15° C.

In an exemplary embodiment, steeping is performed as comprising a 5 h wet steep at 13° C., a 16 h dry steep at 15° C. and a 5 h wet steep at 13° C. In further embodiments, the duration and temperature of wet steeping steps and dry steeping steps to achieve a temperature and/or a total duration of wet and/or dry steeping may vary within the limits disclosed herein.

Germination affects the sensory properties of the pulse by improving digestibility and reducing the sensory properties such as bitterness and astringency that are often considered unpleasant.

In an embodiment, germination is performed for 24 h-120 h which equals 1-5 days (d), preferably for 48 h-72 h (2-3 days). In another embodiment, germination is performed for up to about 100 h. In yet another embodiment, germination is performed for at least 1 h, preferably at least 4 h.

In a further embodiment, germination is performed at a temperature of at least 0° C., preferably 0-30° C., more preferably 5-25° C., yet more preferably 10-20° C., even more preferably at about 15° C.

The method also involves heat treating the pulse by the combination of i) steaming the germinated pulse and ii) drying the steamed pulse by kilning. As discussed above, the conditions used in heat treating the pulse affect the sensory properties of the pulse e.g. by altering content of compounds associated with off-flavors in the pulse. Particularly, steaming performed for more than 20 seconds, such as 1 min or 5 min or 25 min, efficiently reduces the content of 1-hexanol in the pulse and thus reduces beany odor and flavor. Kilning conditions also have an effect on the sensory properties. A lower-temperature kilning gives a product with milder total odor intensity, whereas higher-temperature kilning gives a product with higher roasted and cereal odor and flavor intensity. Kilning may be performed e.g. until a desired residual moisture content is achieved.

In an embodiment, steaming is performed at a temperature of less than 100° C., preferably up to 95° C., more preferably up to 90° C., even more preferably up to 80° C., yet more preferably 70° C. or less, still more preferably 65° C. or less. In another embodiment, steaming is performed at a temperature of at least 50° C., preferably at least 55° C., more preferably at least 60° C. In a further embodiment, steaming is performed at a temperature of 50-100° C., preferably 50-95° C., more preferably 50-90° C., even more preferably 50-80° C., still more preferably 50-75° C., yet more preferably 55-70° C., yet even more preferably 55-65° C., most preferably 60-65° C.

Typically, steaming is performed with a stepwise or gradual temperature increase to a final temperature of any of the temperatures or temperature ranges listed above by feeding on the pulses steam which has the temperature of the desired final temperature or increases towards the desired final temperature. The stepwise or gradual increase is performed over a time period of more than 0 min to 10 h, preferably 1 min to 10 h, more preferably 10 min to 5 h, even more preferably 30 min to 2 h.

In an embodiment, steaming is performed by maintaining the final temperature for more than 20 s, preferably at least 1 min, more preferably at least 5 min. In another embodiment, steaming is performed for less than 60 min, preferably 25 min or less. In yet another embodiment, steaming is performed by maintaining the final temperature for 1-60 min, preferably 1-45 min, more preferably 1-30 min, even more preferably 3-30 min, yet more preferably 5-25 min.

In an embodiment, kilning is performed at a temperature of 105° C. or less, preferably less than 105° C., more preferably 85° C. or less. In another embodiment, kilning is performed at a temperature of 40-105° C., preferably 40-100° C., more preferably 45-95° C., even more preferably 50-95° C., yet more preferably 55-85° C., still more preferably 55-83° C., most preferably 60-83° C. In another embodiment, kilning is performed at a temperature of 75-90° C., preferably 80-85° C. In yet another embodiment, kilning is performed at a temperature of 45-70° C., preferably 50-60° C. The total duration of kilning may be up to 48 h, preferably 0.5-48 h, more preferably 5-48 h, even more preferably 5-30 h, yet more preferably 10-24 h.

Typically, kilning is performed with a stepwise or gradual temperature increase to a final temperature of any of the temperatures or temperature ranges listed above. The stepwise or gradual increase is performed over a time period of up to 48 h, preferably 0.5-48 h, more preferably 5-48 h, even more preferably 5-30 h, yet more preferably 10-24 h.

In an aspect, temperature for kilning is increased stepwise or gradually, and temperature increase steps and temperature holding steps alternate. The temperature increase may be performed for example as follows: 4 h to 6 h hold at 50° C., increase during 1 h to 3 h to 60° C., 4 h to 6 h hold at 60° C., increase during 1 h to 3 h to 70° C., 4 h to 6 h hold at 70° C. The duration and temperature of increase steps and hold steps to achieve a temperature and/or a total duration of kilning may vary within the limits disclosed herein. Typically, the temperature of the final hold step is referred to as the kilning temperature.

In an embodiment, kilning is performed until a moisture content of the pulse after kilning of 10% (w/w) or less is reached, preferably 8% (w/w) or less, more preferably 4-6% (w/w).

Dehulling is a removal of hull i.e. seed coat from a pulse. The seed coat may be used for e.g. production of pulse fiber. Dehulled pulses may have improved appearance, texture and processing and cooking qualities as compared to non-dehulled pulses which include the seed coat. Typically, dehulling involves loosening and detaching of the hull by pearling, pre-milling and milling treatments and removal of the hulls. Removal of the hulls is typically performed by air separation. Dehulling is typically performed on dried pulses.

Pulses may also be treated by milling, which is a process by which materials are reduced from a larger size to a smaller size. As used herein, milling refers to milling of the dried germinated pulses to a flour. Milling can be performed by e.g. hammer milling, pin milling, stone milling or roller milling. Milling may be performed on a dried and/or a dehulled pulse.

In an embodiment, the method further comprises dehulling. In a further embodiment, the method further comprises milling. Milling may or may not be preceded by dehulling.

It will be obvious to a person skilled in the art that, as the technology advances, the inventive concept can be implemented in various ways. The invention and its embodiments are not limited to the examples described below but may vary within the scope of the claims.

### EXAMPLES

### Example 1

Faba bean Vicia faba (vr minor) varieties Kontu and Sampo and yellow pea Pisum sativum variety Loviisa were micromalted as 2 kg batches in a Joe White micromalting unit (Joe White Malting systems, Australia). Micromalting consisted of the steps of steeping, germinating, and kilning. The seeds were steeped using a 26-h three-step steeping program: 5 h wet steep at 13° C., 16 h dry steep at 15° C. and 5 h wet steep at 13° C. The moisture content of the seeds after steeping was 53-57% (w/w). The germination was carried out for 24 h, 48 h and 72 h at 15° C. Germinated seeds were dried using a 21-h kilning program with a stepwise temperature increase to final 55° C. temperature. Reference samples were kilned after the first 5-h wet steep. The final moisture content of the kilned seeds was 4-6% (w/w).

Dehulling of the micromalted beans and peas was done in two steps. First the raw material was processed using a stone mill-type Supermasscolloider MKZA10-15J (Masuko Sangyo Co. Ltd., Kawaguchi, Japan) with a stone gap of ˜5-6 mm and then the detached hulls were removed by air separation. Dehulled samples were milled with a pin disc mill (1×17800 rpm).

Dehulled and milled samples were pre-treated according to Xiaoli et al. (2008) and the concentrations of sucrose, raffinose, stachyose and verbascose were analysed by high performance anion exchange chromatography (HPAEC) (Dionex ICS-3000) with pulse amperometric detection (PAD). The pre- and separation columns (Dionex CarboPac PA-1) were employed at 30° C. with a flow rate of 1 mL/min using the following eluents: milli-Q water, 100 mM NaOH, 300 mM Na-acetate+100 mM NaOH, and 300 mM NaOH.

The alfa-galactosides (raffinose, stachyose and verbascose) were found to dramatically decrease during germination, whereas the content of sucrose increased (Table 1).

TABLE 1
The sucrose and the alfa-galactosides raffinose, stachyose
and verbascose content of faba bean and yellow pea flour
with or without germination. Contents are given as mg/g
dry matter (dm). Total α-galactosides (total α-gal)
is the sum of raffinose, stachyose and verbascose.

| | | | | |
|---|---|---|---|---|
| | | | Total | |
| Raffinose | Stachyose | Verbascose | α-gal | Sucrose |

Faba bean, KONTU

| | | | | | |
|---|---|---|---|---|---|
| Raw material | 3.9 | 8.1 | 24.9 | 37.0 | 28.1 |
| 5 h steeping | 0.8 | 6.5 | 26.0 | 33.3 | 28.6 |
| 1 d germination | 1.0 | 2.6 | 10.2 | 13.8 | 46.3 |
| 2 d germination | 0.2 | 0.7 | 1.0 | 1.9 | 63.0 |
| 3 d germination | 0.3 | 0.1 | 0.2 | 0.6 | 69.3 |

Faba bean, SAMPO

| | | | | | |
|---|---|---|---|---|---|
| Raw material | 5.4 | 11.5 | 29.5 | 46.5 | 34.4 |
| 5 h steeping | 0.9 | 7.9 | 30.3 | 39.0 | 32.8 |
| 1 d germination | 0.7 | 2.2 | 10.2 | 13.1 | 57.9 |
| 2 d germination | 0.2 | 0.6 | 1.3 | 2.0 | 73.9 |
| 3 d germination | 0.3 | 0.6 | 0.9 | 1.9 | 77.1 |

Yellow pea, LOVIISA

| | | | | | |
|---|---|---|---|---|---|
| Raw material | 12.9 | 28.6 | 21.8 | 63.3 | 33.7 |
| 5 h steeping | 1.8 | 24.0 | 18.9 | 44.7 | 40.9 |
| 1 d germination | 1.2 | 5.3 | 2.0 | 8.5 | 83.9 |
| 2 d germination | 0.3 | 0.9 | 0.9 | 2.0 | 89.2 |
| 3 d germination | 0.5 | 1.0 | 0.7 | 2.2 | 103.0 |

### Example 2

Faba bean Vicia faba (vr minor) variety Sampo was treated as in Example 1. The obtained milled flours were made into a porridge. Briefly, the flour was mixed with hot water into a 10% aqueous suspension (w/w) and heated in a microwave oven to >80° C. temperature. After cooling down, the samples were divided into 15-20 g aliquots in plastic vials covered with lids.

The sensory properties of these porridge samples were studied with generic descriptive analysis by a sensory panel consisting of ten trained assessors. The preliminary list of sensory attributes was formulated by five sensory experts. This list was further refined with all 10 assessors in a 1-hour consensus training session. During training, certain attributes were tied to reference products, and these products were bound to a set intensity on the sensory scale. The final profile contained 12 sensory attributes. The attribute lists are shown in Table 2. After panel training, the assessors evaluated the samples in two duplicate sessions. For intensity evaluation, 0-10 line scales were used where 0=the attribute was not perceived at all and 10=the attribute was perceived as very intense in the sample. The samples were presented in a randomised complete block design with three-digit codes. The data were collected using Compusense five version 5.6 (Compusense Inc, Guelph, Canada). The resulting sensory data was analyzed with two-way mixed model analysis of variance (ANOVA) with samples as the fixed factor and assessors as a random factor using SPSS version 26. Tukey's HSD test was used as the post hoc tests for attributes that had a statistically significant (p<0.05) sample effect.

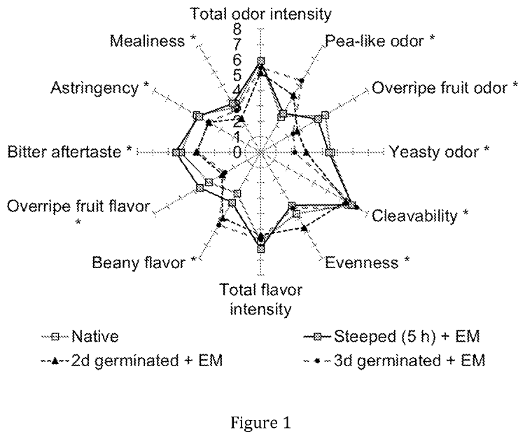

The samples differed in most sensory attributes (FIG. 1, Table 2). Overall, there was a systematic effect of germination time. Native and steeped samples were less pea-like and beany, but more overripe and yeast-like in their odor; they were also more astringent and bitter than the germinated samples. The 2-day and 3-day germinated samples only differed statistically significantly in the intensity of pea-like odor and cleavability, which were more intense for the 3-day germinated sample.

TABLE 2
Effect of germination on the sensory properties of faba bean porridges. The
table overviews the average values, standard deviations (in parentheses) and
post hoc groups (Tukey's HSD) for each sample. Samples with different post
hoc groups (a-c) for each attribute have statistically significant differences.

| | ANOVA | Partial | | | | | | |
|---|---|---|---|---|---|---|---|---|
| Attribute/sample | p value | η² | Native | | | 5 h steeped | | |
| Total odor intensity | 0.208 | | 5.9 | (1.3) | | 5.9 | (1.3) | |
| Pea-like odor | <0.001 | 0.689 | 2.6 | (1.6) | c | 2.9 | (2.1) | c |
| Overripe fruit odor | <0.001 | 0.512 | 4.8 | (2.0) | a | 4.3 | (2.0) | a |
| Yeasty odor | <0.001 | 0.619 | 4.6 | (2.0) | a | 4.4 | (1.8) | a |
| Cleavability | 0.046 | 0.253 | 6.9 | (1.3) | bc | 6.8 | (1.4) | bc |
| Evenness | <0.001 | 0.471 | 4.6 | (2.0) | ab | 4.0 | (1.7) | b |
| Total flavor intensity | 0.17 | | 5.8 | (1.1) | | 6.3 | (1.1) | |
| Beany flavor | <0.001 | 0.596 | 3.1 | (2.0) | b | 3.8 | (1.9) | b |
| Overripe fruit flavor | 0.013 | 0.325 | 3.9 | (2.1) | a | 4.6 | (2.1) | a |
| Bitter aftertaste | 0.015 | 0.318 | 5.2 | (1.9) | a | 5.5 | (1.6) | a |
| Astringency | 0.025 | 0.289 | 4.8 | (1.7) | a | 4.6 | (2.0) | ab |
| Mealiness | 0.07 | | 3.3 | (1.6) | | 3.7 | (1.5) | |
| | ANOVA | Partial | | | | | | |
| Attribute/sample | p value | η² | 2 d germinated | | | 3 d germinated | | |
| Total odor intensity | 0.208 | | 5.2 | (1.6) | | 5.5 | (1.2) | |
| Pea-like odor | <0.001 | 0.689 | 4.3 | (1.6) | b | 5.4 | (1.9) | a |
| Overripe fruit odor | <0.001 | 0.512 | 2.7 | (2.1) | b | 2.4 | (1.6) | b |
| Yeasty odor | <0.001 | 0.619 | 3.0 | (2.2) | b | 2.2 | (2.0) | b |
| Cleavability | 0.046 | 0.253 | 6.4 | (1.7) | c | 7.2 | (1.3) | ab |
| Evenness | <0.001 | 0.471 | 5.7 | (1.7) | a | 4.2 | (1.7) | b |
| Total flavor intensity | 0.17 | | 5.4 | (1.7) | | 5.7 | (1.6) | |
| Beany flavor | <0.001 | 0.596 | 4.9 | (1.7) | a | 5.5 | (1.7) | a |
| Overripe fruit flavor | 0.013 | 0.325 | 2.9 | (1.8) | b | 2.7 | (1.8) | b |
| Bitter aftertaste | 0.015 | 0.318 | 4.2 | (1.8) | b | 4.1 | (1.7) | b |
| Astringency | 0.025 | 0.289 | 3.9 | (2.0) | b | 3.9 | (1.8) | b |
| Mealiness | 0.07 | | 2.5 | (1.3) | | 3.1 | (1.7) | |

### Example 3

Faba bean Vicia faba (vr minor) variety Sampo was treated as in Example 1 except that germination was carried out for 48 hours for all samples. Three different 21-h kilning programs were used with a stepwise temperature increase to a final temperature of 55° C., 83° C. or 105° C. directly after germination. Two samples were steamed prior to kilning in a 10-cm-diameter steaming vessel in which the steam was directed to the beans from below. The temperature of the steam was set as 70° C. and fed from the bottom to the ˜70 cm layer of beans until after 90 minutes from the beginning of the steaming the top of the bean layer reached the target temperature of 70° C. The steaming was then continued with 70° C. steam for an additional 45 minutes. The steamed samples were kilned the same way as unsteamed samples with a final temperature of 83° C. or 105° C. After kilning the samples were dehulled and milled as in Example 1.

Protein solubility was analysed as duplicates by preparing a 10% (w/w) dispersion from the faba bean flour into Milli-Q water, mixing for 30 min, adjusting the pH to 7, mixing for 30 min, pH re-adjustment to 7 and mixing for 30 min. Mixing was performed with a magnetic stirrer. The supernatant was separated by centrifugation (10,000×g, 15 min, 22° C.) and the soluble protein content was determined by analysis of the N-content of the supernatant by the Kjeldahl method and using the coefficient 6.25 to determine the protein content.

Protein solubility of all samples was between 88-91% of total protein for unsteamed samples, whereas steaming at 70° C. decreased protein solubility and a high final temperature in kilning decreased protein solubility further (Table 3).

TABLE 3
Protein solubility of faba bean flour germinated
for 48 h, steamed at 70° C. for 45 min, and
kilned with 55° C., 83° C. or 105° C. final temperature.

| Treatment | Protein solubility at pH 7 |
|---|---|
| Untreated raw material, faba bean Sampo | 89.5 ± 0.7% |
| Kilning 55° C. | 88.6 ± 1.7% |
| Kilning 83° C. | 91.1 ± 0.3% |
| Kilning 105° C. | 88.2 ± 0.2% |
| Steaming 70° C. 45 min, kilning 83° C. | 63.6 ± 0.6% |
| Steaming 70° C. 45 min, kilning 105° C. | 26.5 ± 0.8% |

### Example 4

Faba bean Vicia faba (vr minor) variety Kontu was treated as in Example 1 except that germination was carried out for 48 hours for all samples. The samples were steamed using a similar set up as in Example 3. The time to reach the final temperature of 60° C. was 60 min and the steaming was continued thereafter for either 5 min or 25 min. The time to reach the final temperature of 65° C. was 90 minutes and the steaming was continued thereafter for 25 minutes. One sample was steamed as a shallow 2 cm layer with 100° C. steam for 20 seconds.

For drying the steamed pulses, two different 21-h kilning programs were used with a stepwise temperature increase to a final temperature of 55° C. or 83° C. After kilning the samples were dehulled and milled as in Example 1 with the exception that milling was carried out using a 0.3 mm sieve mill (1×17,800 rpm). Protein solubility was determined as in Example 3.

The used combination of steaming and kilning was found not to deteriorate the protein solubility markedly (Table 4), unless the most severe conditions are used.

TABLE 4
Protein solubility of faba bean flour germinated for
48 h, steamed at 60° C. or 65° C. for 5 or
25 min, and kilned with a final temperature of 55° C. or 83° C.

| Treatment | Protein solubility at pH 7 |
|---|---|
| Kontu Raw material | 91.8 ± 1.7 |
| No steam, kilning 55° C. | 89.6 ± 1.0 |
| No steam, kilning 83° C. | 94.1 ± 1.1 |
| Steaming 60° C. 5 min, kilning 55° C. | 83.3 ± 0.3 |
| Steaming 60° C. 5 min, kilning 83° C. | 80.9 ± 0.4 |
| Steaming 60° C. 25 min, kilning 55° C. | 81.4 ± 0.5 |
| Steaming 60° C. 25 min, kilning 83° C. | 76.0 ± 0.6 |
| Steaming 65° C. 25 min, kilning 55° C. | 79.1 ± 0.3 |
| Steaming 65° C. 25 min, kilning 83° C. | 67.3 ± 1.0 |
| Steaming 100° C. 20 s, kilning 55° C. | 91.5 ± 0.4 |

### Example 5

The samples from Example 4 were analysed for activity of lipase and lipoxygenase as described in Yang et al. 2017. Enzymes were extracted from the milled faba bean flour with 0.1 M potassium phosphate buffer (pH 6.7) on ice, centrifuged and the enzyme activities were analyzed from the supernatants. Lipase activity was measured using a spectrophotometric method with para-nitrophenyl butyrate as a substrate in 50 mM potassium phosphate buffer containing 0.1% (w/v) Triton X-100 (pH 8.0). The increase in absorption at 405 nm during 150 s was measured with an ultraviolet spectrometer (Lambda 25 UV/Vis, Perkin Elmer Inc., USA). The molar extinction coefficient value of 16.05 mM⁻¹ cm⁻¹ for hydrolysed para-nitrophenol was used to calculate the results. Lipase activity was given as μmol min⁻¹ g⁻¹ of dry matter (dm) in flour.

LOX activity was measured by a spectrophotometric method using linoleic acid as the substrate. For the LOX assays, 200 μl of the substrate solution with 10 mM of linoleic acid, 200 μl of the sample extracts and 2.6 ml of 0.1 M potassium phosphate buffer (pH 6) were mixed and incubated for 3 min at 30° C. in a water bath. The reaction was stopped by adding 3 ml of 0.1 N KOH solution and the absorbances were measured at 234 nm (Lambda 25 UV/Vis, Perkin Elmer Inc., USA). The results were calculated using the molar absorptivity of conjugated dienes (ε=26,000 M⁻¹ cm⁻¹). The LOX activity was expressed as mmol min⁻¹ g⁻¹ of dry matter (dm) in flour.

Steaming was found to efficiently reduce both lipase and lipoxygenase activities of the faba bean flour (Table 5).

TABLE 5
Activity of lipase and lipoxygenase in faba bean flour germinated
for 48 h, steamed at 60° C. or 65° C. for 5 or
25 min, and kilned with 55° C. or 83° C. final temperature.

| | Enzyme activity | |
|---|---|---|
| | μmol/min/g dm | |
| Treatment | Lipase | Lipoxygenase |
| Kontu Raw material | 9.4 | 207 |
| No steam, kilning 55° C. | 9.1 | 190 |
| No steam, kilning 83° C. | 6.5 | 82 |
| Steaming 60° C. 5 min, kilning 55° C. | 0.2 | 139 |
| Steaming 60° C. 5 min, kilning 83° C. | 0.1 | 86 |
| Steaming 60° C. 25 min, kilning 55° C. | 0.1 | 107 |
| Steaming 60° C. 25 min, kilning 83° C. | 0.1 | 62 |
| Steaming 65° C. 25 min, kilning 55° C. | 0.1 | 34 |
| Steaming 65° C. 25 min, kilning 83° C. | 0.1 | 25 |
| Steaming 100° C. 20 s, kilning 55° C. | 8.8 | 177 |

### Example 6

The samples from Example 4 were analysed with a generic descriptive analysis. The method was the same as in Example 2 with the following modifications. Briefly, 4 sensory experts formulated the base sensory list based on the sensory profile of Example 2, some attributes were changed, and some reference products were changed. The focus was in the odor, taste and flavor properties; appearance and mouthfeel were not evaluated. Overripe fruit flavor was changed to fermented flavor, pea-like odor to beany odor, and cereal and roasted odor and flavor were added to accommodate the effect of different steaming and kilning steps of Example 4 compared to Example 1.

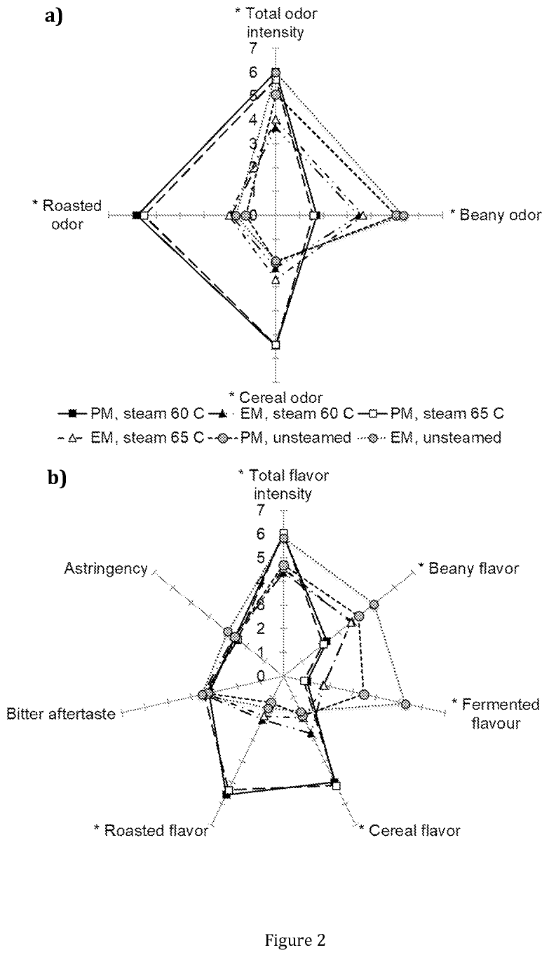

The samples had different sensory properties depending on the combined germination-steaming-kilning treatments (FIGS. 2a and 2b). The unsteamed EM (55° C.) and PM (83° C.) kilned samples were similar apart from total flavor, beany flavor and fermented flavor intensities. However, EM and PM kilning in combination with a preceding steaming step resulted in very different sensory profiles. Steamed PM kilned samples were more intense in cereal and roasted odor and flavor but less intense in beany odor and flavor compared to steamed EM kilned samples.

### Example 7

The volatile compounds in the faba bean samples from Example 4 were measured with headspace-solid phase microextraction gas chromatography-mass spectrometry (HS-SPME-GC-MS). The analysis parameters were based on methods described by Kaseleht et al. (2011) and Akkad et al. (2019). Briefly, 1.5 g of samples were weighed in 20 mL headspace vials and 10 μL of (E,E)-2,4-decadienal in a 93.3 mg/L solution in water with 1% methanol was added as an internal standard (about 933 ng/sample) for relative quantification. The sample was pre-incubated for 5 min at 65° C. and then extracted for 30 min at 65° C. by exposing a 2 cm divinylbenzene/carboxen/polydimethylsiloxane (DVB/Car/PDMS) 50/30-μm fiber (Supelco, USA) to the sample headspace using a Combi PAL CTC autosampler (Agilent Technologies, USA). The sample was agitated at 250 rpm.

After extraction, the volatiles adsorbed in the SPME fibre were thermally desorbed at 270° C. in the injection port of an Agilent 6890/5973 GC-MS. The injector was equipped with a 0.75 mm internal diameter SPME liner. Splitless mode was used in the injector port for 8 min while the fibre was desorbed for 10 min. An HP-Innowax column of 60 m length, 0.25 mm internal diameter and 0.25 μm film thickness was used to separate the volatile compounds. Helium was used as the carrier gas with a flow rate of 1.2 mL/min. The oven temperature was initially maintained at 40° C. for 3 min, then increased to 250° C. at a rate of 7.5° C./min, then held for 9 min. The total run time was 40 minutes. The temperatures of the MS source and quadrupole were 230° C. and 150° C., respectively. The mass spectra were recorded over a 30-400 atomic mass range at 3.85 scans/s. Volatile compounds were identified by comparing their mass spectra and retention indices with those present in the NIST 08 mass spectrum library as well as those of authentic reference compounds using the Chemstation software. All samples were analysed in triplicate. Blank vials containing only water were added between samples to determine the peaks coming from the environment and the SPME fibre. The volatile compound contents were calculated from the relative peak ratios and expressed as (E,E)-2,4-decadienal equivalents (as μg/g flour) with an assumed response factor of 1. The lipid-derived volatile compounds that were most affected by the varying treatments i.e. were present in larger amounts or had large systematic variation were identified by using multivariance statistical analysis (data not shown). The contents of these volatile compounds differed depending on the steaming and kilning conditions (Tables 6 and 7).

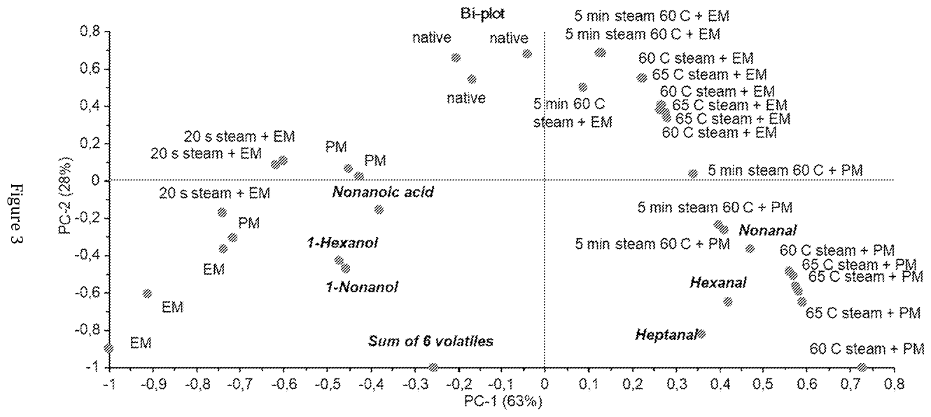

The compound contents of the 10 different samples were used as the dataset in Principal Component Analysis (PCA) done with the Unscrambler X version 10.5. All compounds were mean-centered and autoscaled. The resulting Bi-plot of Scores and Loading is presented in FIG. 3.

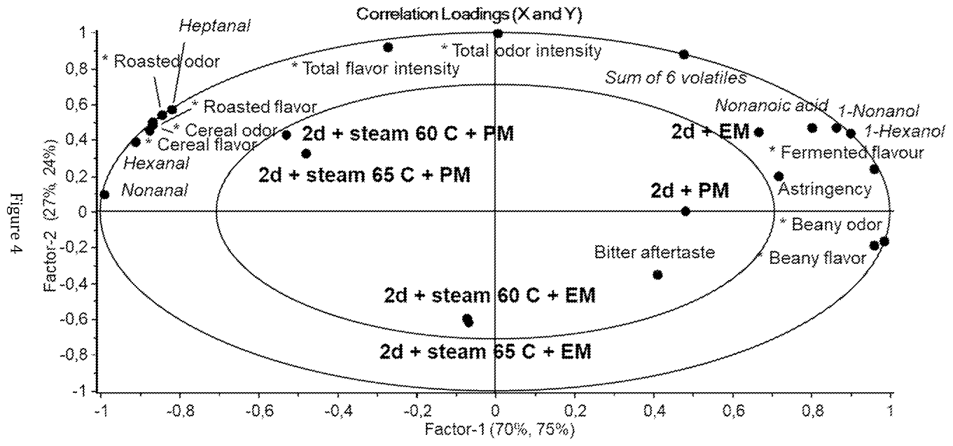

The sensory data from Example 6 and volatile compound data in this Example were combined in a Partial Least Squares Regression (PLSR) model to examine which volatiles were associated with each sensory attribute. The volatile compounds (X-data) were autoscaled while sensory data (Y-data) was only mean-centered. The sample types were projected onto the model as down-weighted to dummy variables. The resulting Correlation Loadings plot is shown in FIG. 4.

TABLE 6
Contents (averages and standard deviations) of selected volatile compounds
in faba bean samples with different steaming and kilning properties.
The volatile contents are expressed as internal standard ((E,E)-2,4-decadienal)
equivalents in μg/g flour with an assumed response factor of 1. Standard
deviations are given in parentheses. Times (min, s) refer to steaming
times. PM = kilning at 83° C.; EM = kilning at 55° C.

| Treatment/Analyte | Hexanal | | Heptanal | | Nonanal | |
|---|---|---|---|---|---|---|
| native | 108.5 | (9.3) | 6.39 | (0.8) | 167.3 | (17.0) |
| PM | 193.3 | (23.0) | 7.90 | (0.5) | 68.7 | (7.1) |
| EM | 107.7 | (14.1) | 11.47 | (1.5) | 54.4 | (14.2) |
| 5 min 60° C. + PM | 416.7 | (46.2) | 21.16 | (2.0) | 252.7 | (28.1) |
| 5 min 60° C. + EM | 195.5 | (15.8) | 8.98 | (1.4) | 144.5 | (14.5) |
| 25 min 60° C. + PM | 575.7 | (70.7) | 26.68 | (3.7) | 424.9 | (56.1) |
| 25 min 60° C. + EM | 239.0 | (25.1) | 10.91 | (1.2) | 245.6 | (29.1) |
| 25 min 65° C. + PM | 538.0 | (15.2) | 27.45 | (1.1) | 362.7 | (14.5) |
| 25 min 65° C. + EM | 239.3 | (20.8) | 11.42 | (1.5) | 234.7 | (23.4) |
| 20 s 100° C. + EM | 76.5 | (7.9) | 7.69 | (0.7) | 26.2 | (1.6) |

| Treatment/Analyte | 1-hexanol | | 1-nonanol | | Nonanoic acid | |
|---|---|---|---|---|---|---|
| native | 93.0 | (4.6) | 22.1 | (1.3) | 54.7 | (17.6) |
| PM | 698.7 | (73.0) | 99.3 | (12.3) | 54.8 | (28.3) |
| EM | 1147.5 | (132.1) | 214.8 | (39.1) | 48.3 | (9.7) |
| 5 min 60° C. + PM | 76.8 | (9.8) | 14.9 | (1.9) | 17.5 | (3.0) |
| 5 min 60° C. + EM | 37.6 | (3.6) | 11.3 | (1.5) | 19.4 | (10.4) |
| 25 min 60° C. + PM | 34.9 | (3.8) | 10.1 | (1.0) | 22.1 | (2.6) |
| 25 min 60° C. + EM | 20.2 | (2.1) | 4.7 | (0.2) | 14.9 | (2.5) |
| 25 min 65° C. + PM | 31.2 | (0.8) | 9.0 | (0.4) | 21.9 | (3.1) |
| 25 min 65° C. + EM | 20.4 | (1.6) | 4.8 | (0.3) | 15.2 | (1.9) |
| 20 s 100° C. + EM | 857.4 | (102.8) | 116.6 | (16.2) | 44.6 | (4.9) |

TABLE 7
Sum of contents of the six volatiles hexanal, heptanal, nonanal, 1-hexanol, 1-nonanol
and nonanoic acid or the three volatiles 1-hexanol, 1-nonanol and nonanoic acid
in μg/g flour sample. Standard deviations are given in parentheses. Also given
is the proportion of 1-hexanol (1-hex) in the total content of the six volatiles
(6 vol) and the proportion of the three volatiles 1-hexanol, 1-nonanol and nonanoic
acid (3 vol) in the total content of the six volatiles. Times (min, s) refer to
steaming times. PM = kilning at 83° C.; EM = kilning at 55° C.

| | Sum of | | Sum of | | 1-hex/6 vol | 3 vol/6 vol |
|---|---|---|---|---|---|---|
| Treatment/Analyte | 3 volatiles | | 6 volatiles | | (%) | (%) |
| native | 169.8 | (24) | 452.1 | (40) | 20.6 | 37.6 |
| PM | 852.8 | (114) | 1122.7 | (141) | 62.2 | 76.0 |
| EM | 1410.6 | (181) | 1584 | (200) | 72.4 | 89.1 |
| 5 min 60° C. + PM | 109.2 | (15) | 800 | (90) | 9.6 | 13.7 |
| 5 min 60° C. + EM | 68.3 | (16) | 417 | (47) | 9.0 | 16.4 |
| 25 min 60° C. + PM | 67.1 | (7.4) | 1094 | (137) | 3.2 | 6.1 |
| 25 min 60° C. + EM | 39.8 | (4.8) | 535 | (60) | 3.8 | 7.4 |
| 25 min 65° C. + PM | 62.1 | (4.3) | 990 | (33) | 3.2 | 6.3 |
| 25 min 65° C. + EM | 40.4 | (3.8) | 526 | (49) | 3.9 | 7.7 |
| 20 s 100° C. + EM | 1018.6 | (124) | 1129 | (132) | 75.9 | 90.2 |

### Example 8

White lupin Lupinus albus and yellow pea Pisum sativum variety Loviisa was treated as in Example 1 except that germination was carried out for 48 hours for all samples. The samples were steamed using a similar set up as in Example 3. The time to reach the final temperature of 60° C. was 60 min and the steaming was continued thereafter for 25 min.

For drying the steamed pulses, a 21-h kilning program was used with a stepwise temperature increase to a final temperature of 55° C. After kilning the samples were dehulled and milled with a laboratory scale mill equipped with 0.5 mm sieve at rotor speed of 12,000 rpm.

Lipase and lipoxygenase (LOX) enzyme activities were analyzed as in Example 5. Steaming was found to efficiently reduce both lipase and lipoxygenase activities of white lupin and yellow pea flour (Table 8).

TABLE 8
Activity of lipase and lipoxygenase in white lupin and yellow pea
flour with different 1) untreated, 2) germinated for 48 h and
kilned with 55° C. final temperature and 3) germinated for
48 h, steamed at 60° C. and kilned with 55° C. final temperature.

| | | Enzyme activity | |
|---|---|---|---|
| | | (μmol/min/g dm) | |
| Raw material | Treatment | Lipase | Lipoxygenase |
| White lupin | — | 7.99 ± 0.14 | 59.4 ± 8.64 |
| White lupin | Germination + | 8.05 ± 0.08 | 22.9 ± 0.54 |
| | kilning 55° C. | | |
| White lupin | Germination, | 0 | 3.68 ± 0.37 |
| | steaming 60° C. + | | |
| | kilning 55° C. | | |
| Yellow pea | — | 20.30 ± 0.08 | 232.3 ± 12.3 |
| Yellow pea | Germination + | 7.43 ± 0.11 | 98.3 ± 4.15 |
| | kilning 55° C. | | |
| Yellow pea | Germination, | 0.08 ± 0.00 | 69.9 ± 1.02 |
| | steaming 60° C. + | | |
| | kilning 55° C. | | |

### Example 9

The volatile compounds in the white lupin and yellow pea samples from Example 8 were analyzed as in Example 7. Those volatile compounds that in Example 7 were found to be markers for flavor properties are presented in Tables 9 and 10. The effect of germination, steaming and kilning on these volatile compounds was very similar in white lupin and yellow pea as in faba bean.

TABLE 9
Contents (averages and standard deviations) of selected volatile compounds
in white lupin and yellow pea samples with different steaming and kilning
properties. The volatile contents are expressed as internal standard
((E,E)-2,4-decadienal) equivalents in μg/g flour with an assumed response
factor of 1. Standard deviations are given in parentheses.

| Raw material | Treatment | Hexanal | | Heptanal | | Nonanal | |
|---|---|---|---|---|---|---|---|
| White lupin | — | 44.8 | (9.4) | 0.0 | (0.0) | 81.0 | (14.2) |
| White lupin | Germination, | 131.4 | (15.7) | 36.6 | (4.7) | 158.9 | (2.1) |
| | kilning 55° C. | | | | | | |
| White lupin | Germination, | 264.4 | (54.7) | 71.7 | (11.1) | 328.3 | (49.9) |
| | steaming 60° C., | | | | | | |
| | kilning 55° C. | | | | | | |
| Yellow pea | — | 330.2 | (152.3) | 22.0 | (10.7) | 424.3 | (233.9) |
| Yellow pea | Germination, | 205.4 | (49.9) | 19.2 | (4.8) | 78.8 | (17.2) |
| | kilning 55° C. | | | | | | |
| Yellow pea | Germination, | 188.8 | (50.9) | 61.7 | (17.3) | 98.0 | (12.5) |
| | steaming 60° C., | | | | | | |
| | kilning 55° C. | | | | | | |

| Raw material | Treatment | 1-hexanol | | 1-nonanol | | Nonanoic acid | |
|---|---|---|---|---|---|---|---|
| White lupin | — | 555.0 | (78.1) | 115.5 | (13.6) | 155.2 | (10.0) |
| White lupin | Germination, | 1518.7 | (216.4) | 147.3 | (26.3) | 99.9 | (10.9) |
| | kilning 55° C. | | | | | | |
| White lupin | Germination, | 17.0 | (2.9) | 0.0 | (0.0) | 110.9 | (12.2) |
| | steaming 60° C., | | | | | | |
| | kilning 55° C. | | | | | | |
| Yellow pea | — | 315.3 | (164.9) | 178.4 | (94.3) | 171.6 | (140.7) |
| Yellow pea | Germination, | 557.5 | (126.6) | 64.1 | (18.4) | 45.1 | (0.5) |
| | kilning 55° C. | | | | | | |
| Yellow pea | Germination, | 160.0 | (41.1) | 7.9 | (0.3) | 44.6 | (22.8) |
| | steaming 60° C., | | | | | | |
| | kilning 55° C. | | | | | | |

TABLE 10
Sum of contents of the six volatiles hexanal, heptanal, nonanal, 1-hexanol, 1-
nonanol and nonanoic acid or the three volatiles 1-hexanol, 1-nonanol and nonanoic
acid in μg/g flour sample. Standard deviations are given in parentheses. Also
given is the proportion of 1-hexanol (1-hex) in the total content of the six
volatiles (6 vol) and the proportion of the three volatiles 1-hexanol, 1-nonanol
and nonanoic acid (3 vol) in the total content of the six volatiles.

| | | Sum of 3 | | Sum of 6 | | 1-Hex/6 vol | | 3 vol/6 vol | |
|---|---|---|---|---|---|---|---|---|---|
| Raw material | Treatment | volatiles | | volatiles | | (%) | | (%) | |
| White lupin | — | 825.7 | (101.7) | 951.5 | (125.4) | 58 | (0.5) | 87 | (0.7) |
| White lupin | Germination, | 1765.9 | (253.6) | 2092.8 | (276.1) | 73 | (0.8) | 84 | (1.0) |
| | kilning 55° C. | | | | | | | | |
| White lupin | Germination, | 127.9 | (9.3) | 792.3 | (106.4) | 2 | (0.1) | 16 | (3.4) |
| | steaming 60° C., | | | | | | | | |
| | kilning 55° C. | | | | | | | | |
| Yellow pea | — | 665.3 | (399.9) | 1441.7 | (796.7) | 22 | (0.8) | 45 | (2.6) |
| Yellow pea | Germination, | 666.7 | (145.5) | 970.2 | (217.3) | 57 | (0.2) | 69 | (0.4) |
| | kilning 55° C. | | | | | | | | |
| Yellow pea | Germination, | 212.4 | (63.6) | 561.0 | (144.3) | 29 | (0.0) | 38 | (1.6) |
| | steaming 60° C., | | | | | | | | |
| | kilning 55° C. | | | | | | | | |

### REFERENCES

Akkad, R., Kharraz, E., Han, J., House, J. D., & Curtis, J. M. (2019). Characterisation of the volatile flavour compounds in low and high tannin faba beans (Vicia faba var. minor) grown in Alberta, Canada. Food Research International, 120(December 2018), 285-294.
Kaseleht, K., Leitner, E., & Paalme, T. (2011). Determining aroma-active compounds in Kama flour using SPME-GC/MS and GC-olfactometry. Flavour and Fragrance Journal, 26(2), 122-128.
Xiaoli et al. (2008) Determination of oligosaccharide contents in 19 cultivars of chickpea (Cicer arietinum L) seeds by high performance liquid chromatography. Food Chem 111, 215-219.
Yang et al (2017) Lipid-modifying enzymes in oat and faba bean. Food Research International 100, 335-343.

1-27. (canceled)

28. A method of preparing a heat-treated germinated pulse, the method comprising the steps of:
a) steeping,
b) germinating,
c) steaming at a temperature of up to 95° C. for more than 20 s, and
d) after the steaming of step c), kilning at less than 105° C.

29. The method according to claim 28, wherein the method further comprises the step of:
e) dehulling.

30. The method according to claim 28, wherein the method further comprises the step of:
f) milling.

31. The method according to claim 28, wherein steeping comprises wet steeping and optionally dry steeping and/or steeping is performed to achieve a moisture content of the pulse seeds of 40-60% (w/w).

32. The method according to claim 28, wherein germinating is performed at 5-25° C. for 24-120 h.

33. The method according to claim 28, wherein steaming is performed by feeding steam to increase the temperature to 50-95° C. and maintaining the temperature at 50-95° C. for 1-60 min.

34. The method according to claim 28, wherein steaming is performed at 50-95° C., preferably at 50-75° C.

35. The method according to claim 28, wherein steaming is performed for 1-60 min, preferably 1-30 min.

36. The method according to claim 28, wherein kilning is performed by increasing the temperature to a temperature of 40-100° C. over a time period of 5-48 h.

37. The method according to claim 28, wherein kilning is performed at a temperature of 40-100° C.

38. The method according to claim 28, wherein moisture content of the pulse after kilning is 10% (w/w) or less.

39. The method according to claim 28, wherein the pulse is selected from the group consisting of Vicia faba, Pisum sativum, Cicer arietinum, Lens culinaris, Lupinus sp., Phaseolus sp., Vigna sp. and a mixture thereof.

40. A heat-treated germinated pulse comprising a 1-hexanol content of less than 200 μg/g, preferably less than 180 μg/g, more preferably less than 100 μg/g, even more preferably less than 80 μg/g, most preferably less than 50 μg/g, and a 1-nonanol content of less than 50 μg/g.

41. The heat-treated germinated pulse according to claim 40, wherein the heat-treated germinated pulse comprises a 1-nonanol content of less than 30 μg/g, more preferably of less than 20 μg/g.

42. The heat-treated germinated pulse according to claim 40, wherein the heat-treated germinated pulse comprises a volatiles content of less than 250 μg/g, preferably less than 220 μg/g, more preferably less than 150 μg/g, most preferably less than 110 μg/g, wherein the volatiles content is a sum of content of 1-hexanol, 1-nonanol and nonanoic acid in μg/g.

43. The heat-treated germinated pulse according to claim 40, wherein the heat-treated germinated pulse comprises a 1-hexanol content that is less than 40% of the sum of content of heptanal, hexanal, nonanal, 1-hexanol, 1-nonanol and nonanoic acid, preferably less than 35%, more preferably less than 30%, even more preferably less than 15%, yet more preferably less than 10%, most preferably less than 5%.

44. The heat-treated germinated pulse according to claim 40, wherein the heat-treated germinated pulse comprises a total content of 1-hexanol, 1-nonanol and nonanoic acid that is less than 50% of the sum of content of heptanal, hexanal, nonanal, 1-hexanol, 1-nonanol and nonanoic acid, preferably less than 45%, more preferably less than 40%, even more preferably less than 20%, yet more preferably less than 15%, most preferably less than 10%.

45. The heat-treated germinated pulse according to claim 40, wherein the pulse comprises a lipase activity of 1 mol/min/g dry matter (dm) or less, preferably less than 1 mol/min/g dm, more preferably 0.5 mol/min/g dm or less, even more preferably 0.2 mol/min/g dm or less.

46. The heat-treated germinated pulse according to claim 40, wherein the heat-treated germinated pulse comprises a protein solubility of at least 60% of total protein, preferably at least 65%, more preferably at least 70%.

47. The heat-treated germinated pulse according to claim 40, wherein the heat-treated germinated pulse comprises an alpha-galactoside content of 20 mg/g dm or less, preferably 15 mg/g dm or less, more preferably 10 mg/g dm or less, even more preferably 5 mg/g dm or less, wherein the alpha-galactoside content is the sum of content of raffinose, stachyose and verbascose in mg/g dm.

48. The heat-treated germinated pulse according to claim 40, wherein the heat-treated germinated pulse comprises a sucrose content of at least 20 mg/g dm, preferably at least 30 mg/g dm, more preferably at least 40 mg/g dm, even more preferably at least 50 mg/g dm.

49. A food or feed product comprising the heat-treated germinated pulse according to claim 40.
